(19) United States
(12) Patent Application Publication
(10) Pub. No.: US 2005/0077016 A1
(43) Pub. Date: Apr. 14, 2005

(54) Vertical window blind including first and second slat units that can be adjusted independently with respect to their tilting angles

(76) Inventor: Hsiang-Mei Kuo, Chiayi City (TW)

Correspondence Address: LADAS & PARRY LLP, 224 SOUTH MICHIGAN AVENUE, SUITE 1200, CHICAGO, IL, 60604, US

(21) Appl. No.: 10/684,887

(22) Filed: Oct. 14, 2003

(51) Int. Cl. E06B 9/36

(52) U.S. Cl. 160/176.1 V

(57) ABSTRACT

A vertical window blind includes first and second slat units, each of which includes vertical slats. The first and second slat units are suspended respectively on first and second end portions of a headrail, and have tilting angles that are independently and respectively controlled by first and second angle-adjusting mechanisms. Each of the first and second angle-adjusting mechanisms includes a shaft journalled within the headrail, an operating rod connected operatively to the shaft and operable so as to actuate axial rotation of the shaft, and slat holders, each of which includes a slat hook coupled to the shaft such that axial rotation of the shaft results in corresponding rotation of the slat hook. Each of the vertical slats has an uppermost end connected to a respective one of the slat hooks.

### BACKGROUND OF THE INVENTION

1. Field of the Invention

The invention relates to a window blind, more particularly to a vertical window blind with a first set of vertical slats whose tilting angle can be adjusted independently from that of a second set of the vertical slats.

2. Description of the Related Art

A conventional vertical window blind includes a hollow horizontal headrail, an angle-adjusting mechanism, and a slat unit. The angle-adjusting mechanism includes a horizontal shaft journalled within the headrail and extending along a longitudinal direction of the headrail, an operating rod connected operatively to the shaft and operable so as to actuate axial rotation of the shaft, and a plurality of slat holders, each of which includes a slat hook coupled to the shaft such that axial rotation of the shaft results in corresponding rotation of the slat hook about an axis transverse to the longitudinal direction. The slat unit includes a plurality of parallel vertical slats, each of which has an uppermost end connected to the slat hook of a respective one of the slat holders.

The conventional vertical window blind achieves the purposes of expanding the vertical slats along the headrail, collecting the vertical slats on one end of the headrail, and adjusting the tilting angle of the vertical slats to control passage of light through the vertical window blind. However, all of the vertical slats are adjusted simultaneously to the same tilting angle upon operation of the operating rod. As such, in the conventional vertical window blind, it is not possible to adjust the vertical slats to control independently passage of light through different portions of the vertical window blind.

### SUMMARY OF THE INVENTION

Therefore, the object of the present invention is to provide a vertical window blind with vertical slats that can be adjusted in a manner to control independently passage of light through left and right portions of the vertical window blind.

According to the present invention, a vertical window blind comprises a hollow horizontal headrail, a first angle-adjusting mechanism, a first slat unit, a second angle-adjusting mechanism, and a second slat unit. The hollow horizontal headrail extends in a longitudinal direction, and has first and second end portions opposite to each other in the longitudinal direction. The first angle-adjusting mechanism includes a first horizontal shaft, a first adjusting unit, and a plurality of first slat holders. The first horizontal shaft is journalled within the headrail and extends along the longitudinal direction. The first adjusting unit is connected operatively to the first horizontal shaft and is operable so as to actuate axial rotation of the first horizontal shaft. The first slat holders are disposed in the first end portion of the headrail and are slidable along the first horizontal shaft. Each of the first slat holders includes a first slat hook that has an inner end disposed in the headrail and coupled to the first horizontal shaft such that axial rotation of the first horizontal shaft results in corresponding rotation of the first slat hook about an axis transverse to the longitudinal direction, and an outer end opposite to the inner end and disposed externally of the headrail. The first slat unit includes a plurality of parallel vertical slats, each of which has an uppermost end connected to the outer end of the first slat hook of a respective one of the first slat holders. The second angle-adjusting mechanism includes a second horizontal shaft, a second adjusting unit, and a plurality of second slat holders. The second horizontal shaft is journalled within the headrail and extends along the longitudinal direction. The second adjusting unit is connected operatively to the second horizontal shaft and is operable so as to actuate axial rotation of the second horizontal shaft. The second slat holders are disposed in the second end portion of the headrail and are slidable along the second horizontal shaft. Each of the second slat holders includes a second slat hook that has an inner end disposed in the headrail and coupled to the second horizontal shaft such that axial rotation of the second horizontal shaft results in corresponding rotation of the second slat hook about an axis transverse to the longitudinal direction, and an outer end opposite to the inner end and disposed externally of the headrail. The second slat unit includes a plurality of parallel vertical slats, each of which has an uppermost end connected to the outer end of the second slat hook of a respective one of the second slat holders. The tilting angle of the first slat unit can be adjusted independently from that of the second slat unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a vertical window blind according to the present invention;

FIG. 2 is a schematic, top view of the preferred embodiment to illustrate operation of a first angle-adjusting mechanism; and

FIG. 3 is a schematic, top view of the preferred embodiment to illustrate operation of a second angle-adjusting mechanism.

### DETAILED DESCRIPTION OF THE PREFERRED EMBODIMENT

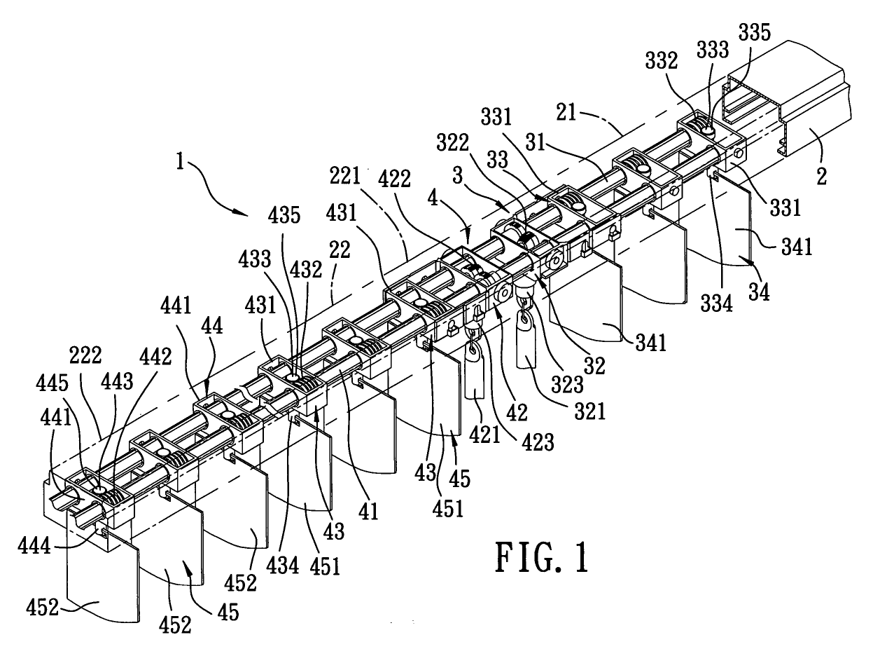

Referring to FIGS. 1 to 3, the preferred embodiment of a vertical window blind 1 according to the present invention is shown to include a hollow horizontal headrail 2, a first angle-adjusting mechanism 3, a first slat unit 34, a second angle-adjusting mechanism 4, and a second slat unit 45.

The headrail 2 extends in a longitudinal direction, and has first and second end portions 21, 22 opposite to each other in the longitudinal direction. The second end portion 22 of the headrail 2 has first and second sections 221, 222 opposite to each other in the longitudinal direction. Furthermore, the headrail 2 has a U-shaped cross-section along a vertical plane transverse to the longitudinal direction and is adapted to be mounted on a wall (not shown) above a window (not shown).

The first angle-adjusting mechanism 3 includes a first horizontal shaft 31, a first adjusting unit 32, and a plurality of first slat holders 33.

The first horizontal shaft 31 is journalled within the headrail 2 and extends along the longitudinal direction.

The first adjusting unit 32 is connected operatively to the first horizontal shaft 31 and is operable so as to actuate axial rotation of the first horizontal shaft 31. In particular, the first adjusting unit 32 includes an operating rod 321 that has an inner end portion 322 disposed in the headrail 2 and coupled to the first horizontal shaft 31 such that axial rotation of the rod 321 about an axis transverse to the longitudinal direction results in corresponding rotation of the first horizontal shaft 31, and an outer end portion 323 extending downwardly from the inner end portion 322 of the rod 321 and disposed externally of the headrail 2.

The first slat holders 33 are disposed in the first end portion 21 of the headrail 2 and are slidable along the first horizontal shaft 31. In this embodiment, each of the first slat holders 33 includes a first slat hook 335 that has an inner end 333 disposed in the headrail 2 and coupled to the first horizontal shaft 31 such that axial rotation of the first horizontal shaft 31 results in corresponding rotation of the first slat hook 335 about an axis transverse to the longitudinal direction, and an outer end 334 opposite to the inner end 333 of the first slat hook 335 and disposed externally of the headrail 2. In particular, each of the first slat holders 33 further includes a first coupling unit that interconnects the inner end 333 of the first slat hook 335 to the first horizontal shaft 31. More particularly, each of the first slat holders 33 further includes a first cage 331. The first coupling unit of each of the first slat holders 33 includes a first worm gear 332 mounted in the first cage 331 and sleeved co-rotatably on the first horizontal shaft 31, and a first worm formed on the inner end 333 of the first slat hook 335 of the first slat holder 33 and meshing with the first worm gear 332.

The first slat unit 34 includes a plurality of parallel vertical slats 341, each of which has an uppermost end connected to the outer end 334 of the first slat hook 335 of a respective one of the first slat holders 33.

The second angle-adjusting mechanism 4 includes a second horizontal shaft 41, a second adjusting unit 42, and a plurality of second slat holders.

The second horizontal shaft 41 is journalled within the headrail 2, and extends along the longitudinal direction.

The second adjusting unit 42 is connected operatively to the second horizontal shaft 41, and is operable so as to actuate axial rotation of the second horizontal shaft 41. In particular, the second adjusting unit 42 includes an operating rod 421 that has an inner end portion 422 disposed in the headrail 2 and coupled to the second horizontal shaft 41 such that axial rotation of the rod 421 about an axis transverse to the longitudinal direction results in corresponding rotation of the second horizontal shaft 41, and an outer end portion 423 that extends downwardly from the inner end portion 422 of the rod 421 and that is disposed externally of the headrail 2.

The second slat holders include first and second sets 43, 44 disposed respectively in the first and second sections 221, 222 of the second end portion 22 of the headrail 2, and are slidable along the second horizontal shaft 41.

Each of the second slat holders in the first set 43 includes a second slat hook 435 that has an inner end 433 disposed in the headrail 2 and coupled to the second horizontal shaft 41 such that axial rotation of the second horizontal shaft 41 results in corresponding rotation of the second slat hook 435 about an axis transverse to the longitudinal direction, and an outer end 434 opposite to the inner end 433 of the second slat hook 435 and disposed externally of the headrail 2. In particular, each of the second slat holders in the first set 43 further includes a second coupling unit that interconnects the inner end 433 of the second slat hook 435 to the second horizontal shaft 41. More particularly, each of the second slat holders in the first set 43 further includes a second cage 431. The second coupling unit of each of the second slat holders in the first set 43 includes a second worm gear 432 mounted in the second cage 431 and sleeved co-rotatably on the second horizontal shaft 41, and a second worm formed on the inner end 433 of the second slat hook 435 of the second slat holder in the first set 43 and meshing with the second worm gear 432.

Each of the second slat holders in the second set 44 includes a third slat hook 445 that has an inner end 443 disposed in the headrail 2 and coupled to the second horizontal shaft 41 such that axial rotation of the second horizontal shaft 41 results in corresponding rotation of the third slat hook 445 about an axis transverse to the longitudinal direction, and an outer end 444 opposite to the inner end 443 of the third slat hook 445 and disposed externally of the headrail 2. In particular, each of the second slat holders in the second set 44 further includes a third coupling unit that interconnects the inner end 443 of the third slat hook 445 to the second horizontal shaft 41. More particularly, each of the second slat holders in the second set 44 further includes a third cage 441. The third coupling unit of each of the second slat holders in the second set 44 includes a third worm gear 442 mounted in the third cage 441 and sleeved co-rotatably on the second horizontal shaft 41, and a third worm formed on the inner end 443 of the third slat hook 445 of the second slat holder in the second set 44 and meshing with the third worm gear 442.

The second slat unit 45 includes a plurality of first and second parallel vertical slats 451, 452. Each of the first parallel vertical slats 451 has an uppermost end connected to the outer end 434 of the second slat hook 435 of a respective one of the second slat holders in the first set 43. Similarly, each of the second parallel vertical slats 452 has an uppermost end connected to the outer end 435 of the third slat hook 445 of a respective one of the second slat holders in the second set 44.

It is noted that the first adjusting unit 32 is disposed in the first end portion 21 of the headrail 2 adjacent to one of the first slat holders 33 nearest to the second end portion 22 of the headrail 2, whereas the second adjusting unit 42 is disposed in the second end portion 22 of the headrail 2 adjacent to one of the second slat holders nearest to the first end portion 21 of the headrail 2.

It is also noted that each of the first and second horizontal shafts 31, 41 extends from the first end portion 21 to the second end portion 22 of the headrail 2. As such, the first horizontal shaft 31 extends further through the second angle-adjusting mechanism 4, whereas the second horizontal shaft 41 extends further through the first angle-adjusting mechanism 3. In an alternative embodiment, the first horizontal shaft 31 extends solely along the first end portion 21 of the headrail 2, whereas the second horizontal shaft 41 extends solely along the second end portion 22 of the headrail 2.

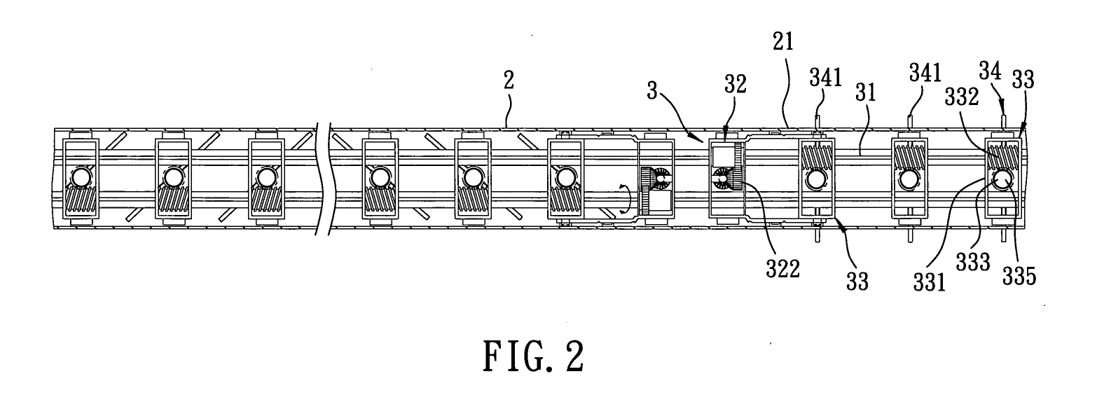

It is further noted that the second and third coupling units are configured such that the second slat holders in the first and second sets 43, 44 rotate in opposite directions when the second horizontal shaft 41 is rotated axially, as best shown in FIG. 2. In particular, each second worm gear 432 is threaded in a first threading direction, and the third worm gear 442 is threaded in a second threading direction opposite to the first threading direction.

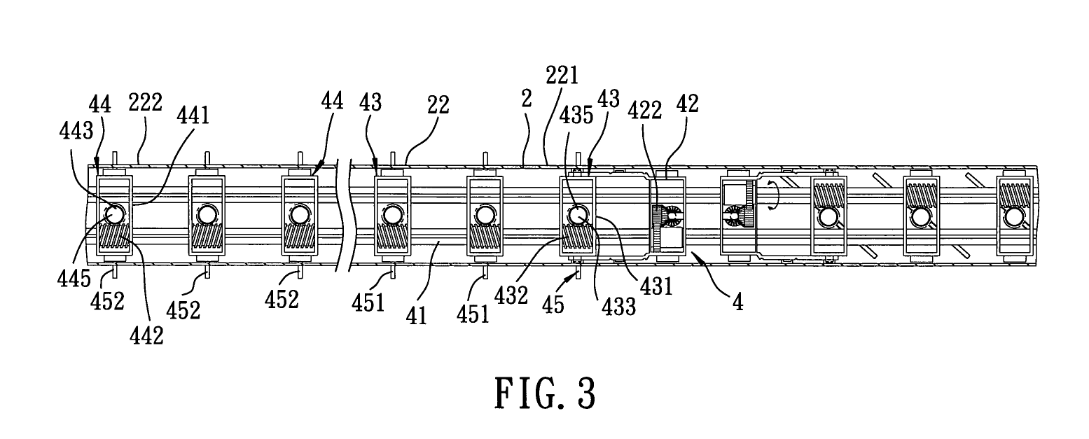

It has thus been shown that the vertical window blind 1 of this invention includes a hollow horizontal headrail 2, first and second angle-adjusting mechanisms 3, 4, and first and second slat units 34, 45. Each of the first and second angle-adjusting mechanisms 3, 4 includes a horizontal shaft 31, 41 journalled within the headrail 2, an adjusting unit 32, 42 connected operatively to the shaft 31, 41 and operable so as to actuate axial rotation of the shaft 31, 41, and slat holders 33, 43, 44, each of which includes a slat hook 335, 435, 445 coupled to the shaft 31, 41 such that axial rotation of the shaft 31, 41 results in corresponding rotation of the slat hooks 335, 435, 445. Each of the first and second slat units 34, 45 includes a plurality of parallel vertical slats 341, 451, 452, each of which has an uppermost end connected to a respective one of the slat hooks 335, 435, 445. The construction as such permits tilting angle of the first and second slat units 34, 45 to be adjusted independently from each other, as best shown in FIG. 3.

While the present invention has been described in connection with what is considered the most practical and preferred embodiment, it is understood that this invention is not limited to the disclosed embodiment but is intended to cover various arrangements included within the spirit and scope of the broadest interpretation so to encompass all such modifications and equivalent arrangements.

1. A vertical window blind comprising:
a hollow horizontal headrail extending in a longitudinal direction, and having first and second end portions opposite to each other in the longitudinal direction;
a first angle-adjusting mechanism including
a first horizontal shaft journalled within said headrail and extending along the longitudinal direction,
a first adjusting unit connected operatively to said first horizontal shaft and operable so as to actuate axial rotation of said first horizontal shaft, and
a plurality of first slat holders disposed in said first end portion of said headrail and slidable along said first horizontal shaft, each of said first slat holders including a first slat hook that has an inner end disposed in said headrail and coupled to said first horizontal shaft such that axial rotation of said first horizontal shaft results in corresponding rotation of said first slat hook about an axis transverse to the longitudinal direction, and an outer end opposite to said inner end and disposed externally of said headrail;
a first slat unit including a plurality of parallel vertical slats, each of which has an uppermost end connected to said outer end of said first slat hook of a respective one of said first slat holders;
a second angle-adjusting mechanism including
a second horizontal shaft journalled within said headrail and extending along the longitudinal direction,
a second adjusting unit connected operatively to said second horizontal shaft and operable so as to actuate axial rotation of said second horizontal shaft, and
a plurality of second slat holders disposed in said second end portion of said headrail and slidable along said second horizontal shaft, each of said second slat holders including a second slat hook that has an inner end disposed in said headrail and coupled to said second horizontal shaft such that axial rotation of said second horizontal shaft results in corresponding rotation of said second slat hook about an axis transverse to the longitudinal direction, and an outer end opposite to said inner end and disposed externally of said headrail; and
a second slat unit including a plurality of parallel vertical slats, each of which has an uppermost end connected to said outer end of said second slat hook of a respective one of said second slat holders;
whereby, tilting angle of said first slat unit can be adjusted independently from that of said second slat unit.

2. The vertical window blind as claimed in claim 1, wherein said second end portion of said headrail has first and second sections opposite to each other in the longitudinal direction,
said second slat holders including a first set disposed in said first section of said second end portion of said headrail, and a second set disposed in said second section of said second end portion of said headrail,
each of said second slat holders in said first set further including a first coupling unit that interconnects said inner end of said second slat hook to said second horizontal shaft,
each of said second slat holders in said second set further including a second coupling unit that interconnects said inner end of said second slat hook to said second horizontal shaft,
said first and second coupling units being configured such that said second slat hooks of said second slat holders in said first and second sets rotate in opposite directions when said second horizontal shaft is rotated axially.

3. The vertical window blind as claimed in claim 2, wherein each of said second slat holders further includes a cage,
said first coupling unit of each of said second slat holders in said first set including
a first worm gear mounted in said cage of said second slat holder in said first set, sleeved co-rotatably on said second horizontal shaft, and threaded in a first threading direction, and
a first worm formed on said inner end of said second slat hook of said second slat holder in said first set and meshing with said first worm gear.

4. The vertical window blind as claimed in claim 3, wherein said second coupling unit of each of said second slat holders in said second set includes
a second worm gear mounted in said cage of said second slat holder in said second set, sleeved co-rotatably on said second horizontal shaft, and threaded in a second threading direction opposite to the first threading direction, and
a second worm formed on said inner end of said second slat hook of said second slat holder in said second set and meshing with said second worm gear.

5. A vertical window blind comprising:
a hollow horizontal headrail extending in a longitudinal direction, and having first and second end portions opposite to each other in the longitudinal direction;
an angle-adjusting mechanism including
a horizontal shaft journalled within said headrail and extending along the longitudinal direction,
an adjusting unit connected operatively to said horizontal shaft and operable so as to actuate axial rotation of said horizontal shaft,
a plurality of first slat holders disposed in said first end portion of said headrail and slidable along said horizontal shaft, each of said first slat holders including a first slat hook that has an inner end disposed in said headrail and coupled to said horizontal shaft such that axial rotation of said horizontal shaft results in corresponding rotation of said first slat hook about an axis transverse to the longitudinal direction, and an outer end opposite to said inner end and disposed externally of said headrail, each of said first slat holders further including a first coupling unit that interconnects said inner end of said first slat hook to said horizontal shaft,
a plurality of second slat holders disposed in said second end portion of said headrail and slidable along said horizontal shaft, each of said second slat holders including a second slat hook that has an inner end disposed in said headrail and coupled to said horizontal shaft such that axial rotation of said horizontal shaft results in corresponding rotation of said second slat hook about an axis transverse to the longitudinal direction, and an outer end opposite to said inner end and disposed externally of said headrail, each of said second slat holders further including a second coupling unit that interconnects said inner end of said second slat hook to said horizontal shaft,
said first and second coupling units being configured such that said first and second slat hooks rotate in opposite directions when said horizontal shaft is rotated axially;
a first slat unit including a plurality of parallel vertical slats, each of which has an uppermost end connected to said outer end of said first slat hook of a respective one of said first slat holders; and
a second slat unit including a plurality of parallel vertical slats, each of which has an uppermost end connected to said outer end of said second slat hook of a respective one of said second slat holders.

6. The vertical window blind as claimed in claim 5, wherein each of said first slat holders further includes a cage, said first coupling unit of each of said first slat holders including
a first worm gear mounted in said cage of said first slat holder, sleeved co-rotatably on said horizontal shaft, and threaded in a first threading direction, and
a first worm formed on said inner end of said first slat hook of said first slat holder and meshing with said first worm gear.

7. The vertical window blind as claimed in claim 6, wherein each of said second slat holders further includes a cage, said second coupling unit of each of said second slat holders including
a second worm gear mounted in said cage of said second slat holder, sleeved co-rotatably on said horizontal shaft, and threaded in a second threading direction opposite to the first threading direction, and
a second worm formed on said inner end of said second slat hook of said second slat holder and meshing with said second worm gear.
